(19) United States
(12) Patent Application Publication
(10) Pub. No.: US 2018/0316242 A1
(43) Pub. Date: Nov. 1, 2018

(54) BRUSHLESS MOTOR

(71) Applicant: HITACHI AUTOMOTIVE SYSTEMS ENGINEERING, LTD., lbaraki (JP)

(72) Inventors: Ippei SUZUKI, Hitachinaka-shi (JP); Youhei KOUNO, Hitachinaka-shi (JP); Hisashi WADA, Hitachinaka-shi (JP)

(73) Assignee: HITACHI AUTOMOTIVE SYSTEMS ENGINEERING, LTD., Ibaraki (JP)

(21) Appl. No.: 15/756,882

(22) PCT Filed: Aug. 2, 2016
(86) PCT No.: PCT/JP2016/072571

§ 371 Date: Mar. 1, 2018

(30) Foreign Application Priority Data
Sep. 2, 2015 (JP) 2015-172458

(51) Int. Cl. H02K 5/24; H02K 21/16

(52) U.S. Cl. CPC H02K 5/24; H02K 3/52; H02K 21/16

(57) ABSTRACT

Provided is a brushless motor having high vibration resistance without fixing a lead wire with varnish or an adhesive. A brushless motor is configured to include: an insulator attached to a salient magnetic pole portion of an armature core; and an armature winding wound around the insulator, in which the insulator has a protrusion at an end portion in an axial direction, the armature winding includes two lead wires of a winding start lead wire and a winding end lead wire and a winding portion formed between the two lead wires, and one of the lead wires is wound around the protrusion before reaching an electrical connection portion.

### TECHNICAL FIELD

The present invention relates to a brushless motor.

### BACKGROUND ART

In recent years, engine auxiliary machines such as an oil pump for idling stop and a water pump for cooling an engine tend to be motorized to improve fuel efficiency of a vehicle. Since motors that drive these auxiliary machines are used in harsh environments where vibration of the engine is directly applied, and are required to have a long life, highly reliable permanent magnet field type brushless motors have been used as such motors.

The permanent magnet field type brushless motor includes a stator in a housing, a yoke fixed to a rotating shaft, a rotor including a permanent magnet fixed to the yoke, and a terminal block in which a plurality of terminals is arranged, the plurality of terminals having connector portions which supply electric power to armature windings, in which a flange which also serves as a cover made of an aluminum alloy or the like is attached to an opening end side of the housing of an output shaft.

The stator has an armature core, and the armature core is fixed to the housing by press-fitting or shrinkage-fitting. The armature core has a plurality of salient magnetic poles arranged at equal intervals over an entire circumference of an inner peripheral side of the armature core, and the armature windings which are wound around the salient magnetic poles through an insulating member and forming a three-phase connection. Each of the armature windings has two lead wires of a winding start lead wire and a winding end lead wire, and the lead wires are electrically connected to the terminal of the terminal block by Tig welding or the like.

In a case where the lead wires are not fixed with varnish or an adhesive, lengths of the lead wires are designed so as not to resonate with a vibration frequency of the engine, to prevent disconnection. Particularly, since the winding end side lead wire becomes structurally long, the winding end side lead wire is structurally designed to be shortened as much as possible (for example, PTL 1).

### CITATION LIST

### Patent Literature

PTL 1: Japanese Patent Application Laid-Open No. 2012-60831

### SUMMARY OF INVENTION

### Technical Problem

In the prior art as in PTL 1, the lead wire is structurally designed to be shortened as much as possible, such that a natural vibration frequency is increased. Depending on the number of cylinders in the engine and the maximum number of revolutions, however, it has been difficult to avoid a vibration frequency band of the engine.

Particularly, there has been problems that, since the winding end side lead wire becomes structurally long and it is difficult to maintain tension thereof, the lead wire is easily deflected by vibration, a film of the armature winding breaks by friction and the lead wire is short-circuited with the adjacent armature winding, and the lead wire is disconnected in the vicinity of an electrical connection portion with the terminal in the terminal block.

In addition, although there is a method in which the lead wire portion is fixed with varnish or an adhesive in order to improve vibration resistance, there has been a problem that manufacturing facilities and working time at the time of assembly are increased, which results in an increase in a cost.

Therefore, an object of the present invention is to provide a brushless motor having high vibration resistance without fixing a lead wire with varnish or an adhesive.

### Solution to Problem

In order to solve the above problems, for example, configurations described in the claims are adopted.

The present application includes a plurality of means for solving the above problems, and examples of such means include a brushless motor including: an insulator attached to a salient magnetic pole portion of an armature core; and an armature winding wound around the insulator, in which the insulator has a protrusion at an end portion in an axial direction, the armature winding includes two lead wires of a winding start lead wire and a winding end lead wire, and a winding portion formed between the two lead wires, and one of the lead wires is wound around the protrusion before reaching an electrical connection portion.

### Advantageous Effects of Invention

According to the present invention, a brushless motor having high vibration resistance without fixing a lead wire with varnish or an adhesive can be provided.

Problems, configurations and effects other than those mentioned above will be clarified by the following descriptions of an embodiment.

### BRIEF DESCRIPTION OF DRAWINGS

FIG. 1 is a perspective view of a stator portion.

FIG. 2 is a cross-sectional view of the stator portion.

FIG. 3 is a connection diagram when coils are Y-connected in the stator portion.

FIG. 4 is a winding diagram when the coils are wound around phases in the stator portion.

FIG. 5 is an external view in a state where winding end portion lead wires of armature windings are wound around insulator protrusions.

FIG. 6 is an enlarged view of a portion electrically connected to a terminal portion of a terminal block after the winding end portion lead wire of the armature winding is wound around the insulator protrusion (part A in FIG. 1).

### DESCRIPTION OF EMBODIMENTS

Hereinafter, an embodiment will be described with reference to the drawings.

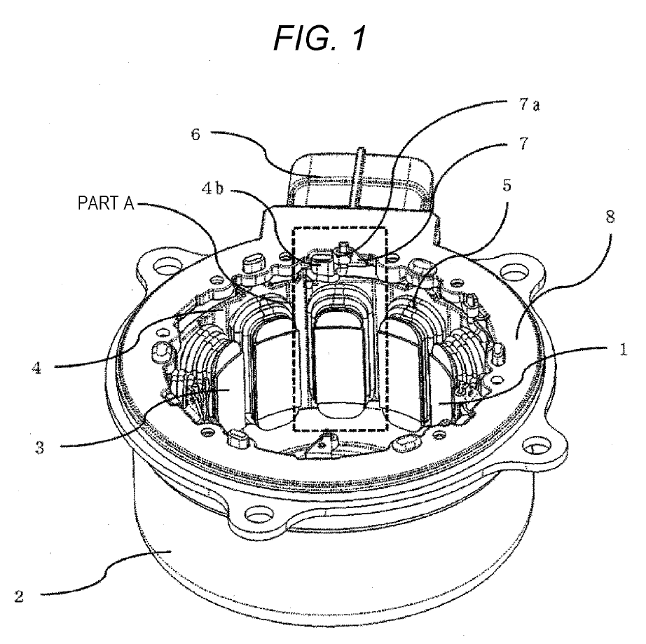

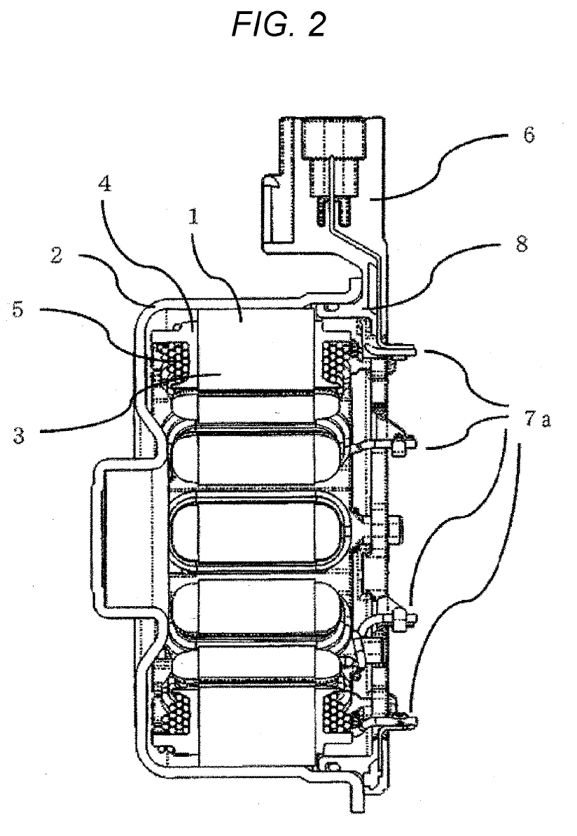

FIG. 1 and FIG. 2 are respectively a perspective view and a cross-sectional view of a stator portion (excluding a rotor portion) of a permanent magnet field type brushless motor according to the present embodiment.

The stator portion has an armature core 1, and fixes the armature core 1 to a housing 2 by press-fitting.

The armature core 1 has a plurality of salient magnetic pole portions 3 arranged at equal intervals over an entire circumference of an inner peripheral side, the salient magnetic pole portions 3 are molded with an insulator 4 which is an insulating member, and armature windings 5 are wound around the salient magnetic pole portions 3 through the insulator 4. A plurality of armature windings 5 are connected to form a stator winding.

A terminal block 8 is formed by resin molding a plurality of bus bars (not illustrated) and a plurality of insulating materials (not illustrated) for connecting the armature windings 5 to an external power supply, and is inserted into the housing 1.

The plurality of bus bars forms terminals 7 for electrical connection with winding start portion lead wires (9a, 9c, and 9e) and winding end portion lead wires (9b, 9d, and 9f) of the armature windings 5, and the lead wires are electrically connected to the terminals at electrical connection portions 7a by Tig welding or the like.

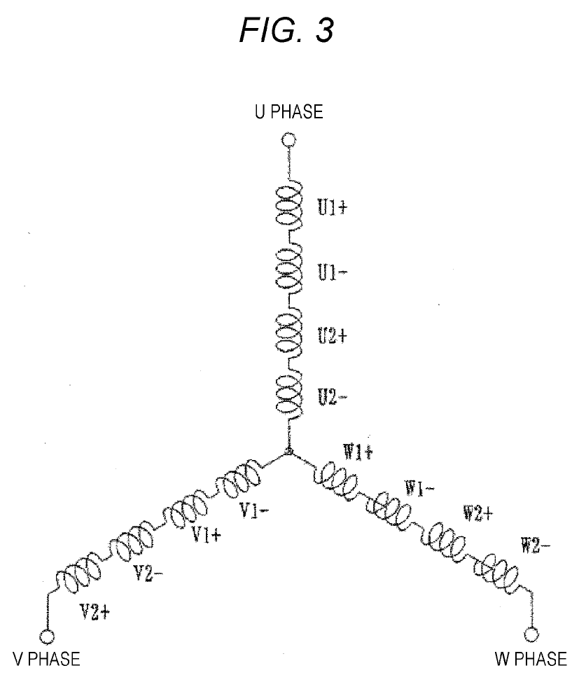

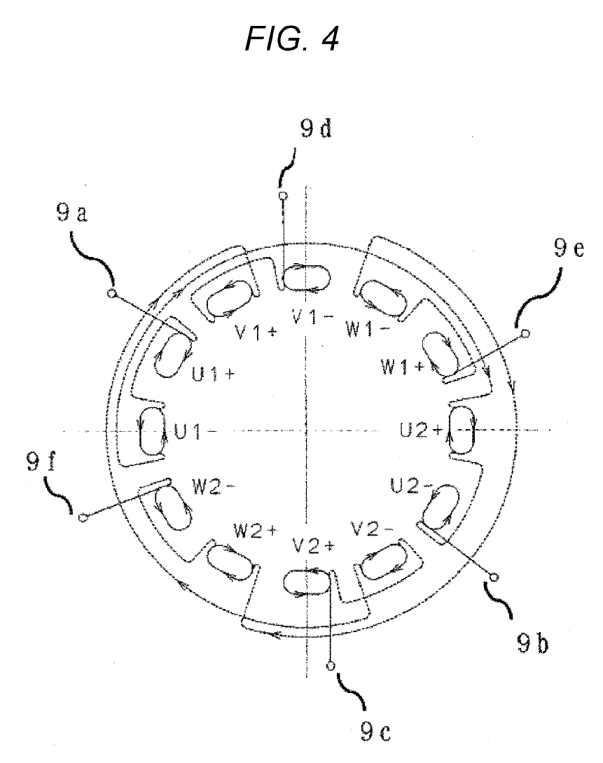

As illustrated in FIGS. 3 and 4, a connection of the armature winding 5 is a four-series Y-connection, and coils of three phases are arranged counterclockwise in the order of U1+, U1−, W2−, W2+, V2+, V2−, U2−, U2+, W1+, W1−, V1−, and V1+ (+ and − indicate that the winding directions are different from each other).

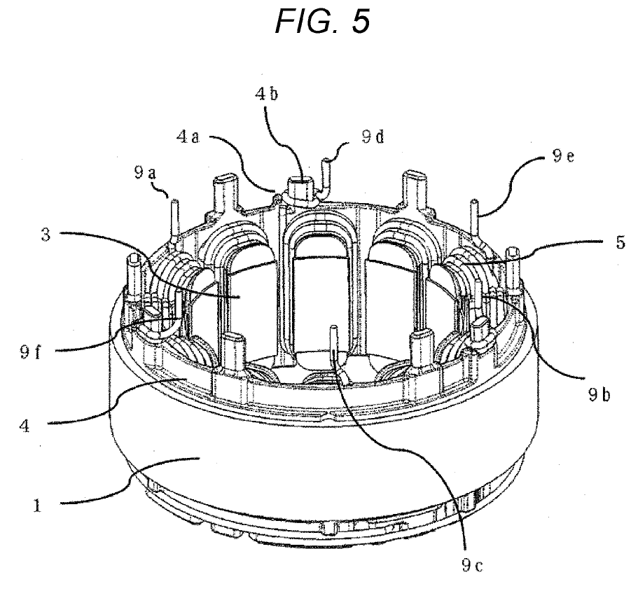

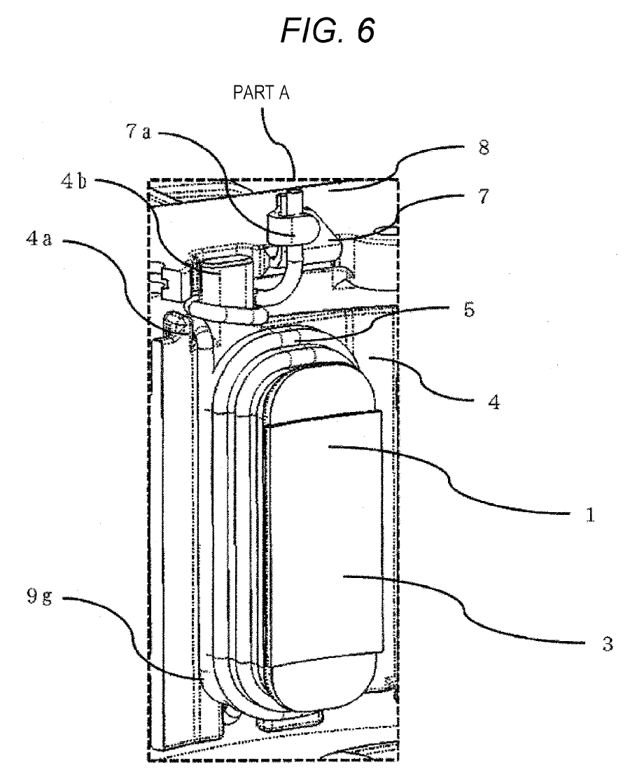

FIG. 5 is an external view in which the winding end portion lead wires (9b, 9d, and 9f) of the armature windings 5 are wound around protrusions 4b of the insulator 4, and FIG. 6 is an enlarged view of a portion electrically connected to a terminal 7 of the terminal block 8 after the winding end portion lead wire is wound around the protrusion 4b of the insulator 4 (part A in FIG. 1).

In a conventional structure, there has been problems that, since between a winding completion portion 9g and the electrical connection portion 7a of the armature winding 5, each of the winding end portion lead wires (9b, 9d, and 9f) is not fixed, becomes structurally long, and it is difficult to maintain tension thereof, the lead wire is easily deflected by vibration, a film of the armature winding 5 breaks by friction and the lead wire is short-circuited with the adjacent armature winding 5, and the lead wire is disconnected in the vicinity of an electrical connection portion 7a with the terminal 7 in the terminal block 8.

Therefore, in the present embodiment, the protrusions 4b are provided at one end of the insulator 4, groove portions 4a each of which is wider than a coil diameter is provided at bases of the protrusions 4b. With this structure, the winding end portion lead wires (9b, 9d, and 9f) are guided into the groove portions 4a while being pulled, and wound around the protrusions 4b. After the lead wires are wounded around the protrusions 4b, forming is performed, the terminal block 8 is incorporated, and the lead wires are electrically connected to the terminals at the electrical connection portions 7a. Here, the protrusions 4b are provided on an outer circumference side of an outermost circumferential surface of a winding portion of the armature windings and closer to a center in a circumferential direction of the insulator 4.

As described above, by winding the winding end portion lead wires (9b, 9d, and 9f) of the armature windings 5 around the protrusions 4b of the insulator 4, slack of the lead wires is suppressed, and at the same time, lengths of the winding end portion lead wires from the electrical connection portions 7a with the terminals 7 of the terminal block 8 (portions to be free) can be greatly shortened, such that a natural vibration frequency is increased, and resonance with an engine vibration frequency can be avoided.

In addition, although in the present embodiment, the winding end portion lead wires of the armature windings are wound around the insulator protrusions, the present invention can also be applied to the winding start portion lead wires.

In addition, although in the present embodiment, the insulator which is an insulating material between a stator core and the armature windings has been described as being molded with the stator core, the present invention can be applied also in a case where the insulator is not molded.

As described above, according to the present invention, since the natural vibration frequency can be increased by shortening the length of the lead wires, resonance with the vibration frequency of the engine can be avoided, the lead wires can be prevented from being disconnected in the vicinity of the electrical connection portions with the terminals in the terminal block, and accordingly, a brushless motor having high vibration resistance can be supplied.

Further, since slack can be suppressed, it is possible to prevent that the film of the armature winding breaks due to friction and the lead wires are short-circuited with the adjacent armature winding, and accordingly, a brushless motor having high vibration resistance can be supplied.

In addition, it is possible to omit varnish and an adhesive, a brushless motor which is inexpensive and excellent in productivity and has high vibration resistance can be supplied.

Note that the present invention is not limited to the above-described embodiment, but includes various modifications. For example, the above-described embodiment has been described in detail in order to describe the present invention in an easy-to-understand manner, and the present invention is not necessarily limited to the embodiment having all the configurations described above. In addition, a part of the configurations of the embodiment can be added with or replaced with another configuration, or can be deleted.

### REFERENCE SIGNS LIST

1 armature core
2 housing
3 salient magnetic pole portion
4 insulator
4a groove portion
4b protrusion
5 armature winding
6 connector portion
7 terminal
7a electrical connection portion
8 terminal block
9a U-phase winding start portion lead wire
9b U-phase winding end portion lead wire
9c V-phase winding start portion lead wire
9d V-phase winding end portion lead wire
9e W-phase winding start portion lead wire
9f W-phase winding end portion lead wire
9g winding completion portion

1. A brushless motor, comprising:
an insulator attached to a salient magnetic pole portion of an armature core; and
an armature winding wound around the insulator,
wherein the insulator has a protrusion at an end portion in an axial direction,
the armature winding includes two lead wires of a winding start lead wire and a winding end lead wire, and a winding portion formed between the two lead wires, and
one of the lead wires is wound around the protrusion before reaching an electrical connection portion.

2. The brushless motor according to claim 1, wherein
the electrical connection portion is provided on a terminal block that connects the armature winding to an external power supply.

3. The brushless motor according to claim 1, wherein
the protrusion is provided on an outer circumference side of an outermost circumferential surface of the winding portion of the armature winding, and is provided closer to a center in a circumferential direction of the insulator.

4. The brushless motor according to claim 1, wherein
a groove serving as a guide for winding the lead wire is provided beside the protrusion.

5. The brushless motor according to claim 1, wherein
the winding end lead wire is wound around the protrusion.
